(19) United States
(12) Patent Application Publication
(10) Pub. No.: US 2006/0104519 A1
(43) Pub. Date: May 18, 2006

(54) System and method for a contiguous support vector machine

(76) Inventors: Jonathan Stoeckel, Bangalore (IN); Glenn Fung, Bryn Mawr, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/262,041

(22) Filed: Oct. 28, 2005

Related U.S. Application Data
(60) Provisional application No. 60/624,620, filed on Nov. 3, 2004.

(51) Int. Cl. G06K 9/62; G06K 9/46; G06K 9/00

(52) U.S. Cl. 382/224; 382/190; 382/128

(57) ABSTRACT

A method of classifying features in digitized images includes providing a plurality of feature points in an n-dimensional space, wherein said feature points have been extracted from a digitized medical image, formulating a support vector machine to classify said feature point into one of two sets, wherein each said feature classification vector is transformed by an adjacency matrix defined by those points that are nearest neighbors of said feature, and solving said support vector machine by a linear optimization algorithm to determine a classifying plane that separates the feature vectors into said two sets.

### CROSS REFERENCE TO RELATED U.S. APPLICATIONS

This application claims priority from “Contiguous Support Vector Machine”, U.S. Provisional Application No. 60/624,620 of Fung, et al., filed Nov. 3, 2004, the contents of which are incorporated herein by reference.

### TECHNICAL FIELD

This invention is directed to the automatic classification of medical images, in particular images of Alzheimer's and related neurological diseases.

### DISCUSSION OF THE RELATED ART

Alzheimer's disease (AD) is currently the most frequent type of dementia for elderly patients. Due to aging populations its occurrence will still increase. Even though no definitive cure has been found for this disease, reliable diagnosis is useful for excluding other dementias, choosing the right treatment and for the development of new treatments.

AD is diagnosed using the criteria from the National Institute of Neurological and Communicative Disorders and Stroke and Alzheimer's Disease and Related Disorders Association (NINCDS-ADRDA). In practice the main tool for evaluating patients are neuro-psychologic tests, that test abilities like memory and language. The Mini Mental State Examination (MMSE) is the most widely used of these tests.

Brain images can also provide some helpful indication of AD. Magnetic resonance imaging (MRI) is used to study possible anatomical changes of the brain. Images showing the local perfusion of the brain can be used for the diagnosis of AD because the perfusion pattern is affected by the disease. One example of this type of imaging is cerebral perfusion imaging acquired by single photon emitting computer tomography (SPECT) using technetium-99m hexamethylpropylene amine oxime (HMPAO) as the tracer. Even though the perfusion pattern and its evolution is not the same for all patients, some hypo-perfusion patterns seem to be typical for the disease. There are three regions known in the art attained by hypo-perfusion: (1) the temporo-parietal region; (2) the posterior cingulate gyri and precunei; and (3) the medial temporal lobe. The first region is known as the predominant pattern for AD, however this region is not found for early AD. The second region is probably more specific and more frequent in early AD. Previous pathological studies have suggested that the third region is the first affected by the disease, however in practice it is only observed in more advanced stages of the disease.

There is no one single perfusion pattern that differentiates AD patients from healthy subjects. Some approaches for a computer aided diagnosis (CAD) system for the analysis of SPECT images for AD can be found in literature. One family is based on the analysis of regions of interest. The mean values for these regions are analyzed using some discriminant functions.

Another approach is statistical parametric mapping (SPM) and its numerous variants. Statistical parametric mapping is widely used in the neurosciences. Its framework was first developed for the analysis of SPECT and PET studies, but is now mainly used for the analysis of functional MRI data. It was not developed specifically to study a single image, but for comparing groups of images. One can use it for diagnostics by comparing the image under study to a group of normal images.

Statistical parametric mapping involves performing a voxelwise statistical test, such as a t-test, comparing the values of the image under study to the mean values of a group of normal images. Subsequently the significant voxels are inferred by using the random field theory. A largely used freely available implementation known as SPM99 has been developed.

### SUMMARY OF THE INVENTION

Exemplary embodiments of the invention as described herein generally include methods and systems for using minimal a-priori information for the analysis of SPECT perfusion images, by obtaining information implicitly from image databases. Another aspect is that the approach is global in that all information in the image can be used at once, as opposed to methods like SPM. Spatial information regarding feature (voxel) locations is incorporated into an optimization program, leading to feature selection where a classifier depends on regions in the brain instead of isolated non-connected voxels.

According to an aspect of the invention, there is provided a method for classifying features in digitized images, including providing a plurality of feature points in an n-dimensional space, wherein said feature points have been extracted from a digitized medical image, formulating a support vector machine to classify said feature point into one of two sets, wherein each said feature classification vector is transformed by an adjacency matrix defined by those points that are nearest neighbors of said feature, and solving said support vector machine by a linear optimization algorithm to determine a classifying plane that separates the feature vectors into said two sets.

According to a further aspect of the invention, the features are extracted from a plurality of digitized images, wherein each said image comprises a set of intensities defined on a lattice of points, and further comprising spatially registering each of said images by estimating an affine transformation between the images.

According to a further aspect of the invention, spatially registering said images further comprises registering each image to a single image, registering said single image to a flipped version of itself, and averaging said single image with said flipped version of itself.

According to a further aspect of the invention, the intensities of each said image are normalized by application of an affine transformation to said intensities.

According to a further aspect of the invention, the affine transformation parameters are estimated on a training set of features wherein the intensities for each training set point have zero mean and a standard deviation of one.

According to a further aspect of the invention, the lattice point intensities are used as features.

According to a further aspect of the invention, the adjacency matrix R is defined by a similarity function r among any two features (fᵢ, fⱼ) wherein a matrix element Rᵢⱼ is defined by Rᵢⱼ, =r(fᵢ,fⱼ)ε{0,1},i,jε{1, . . . ,n}, wherein n is a number of features.

According to a further aspect of the invention, the similarity function is defined by a 3%3%3 mask that selects the 26 nearest neighbors of each said feature.

According to a further aspect of the invention, the features include hypo-perfusion patterns characteristic of Alzhiemer's disease.

According to another aspect of the invention, there is provided a program storage device readable by a computer, tangibly embodying a program of instructions executable by the computer to perform the method steps for classifying features in digitized images.

### BRIEF DESCRIPTION OF THE DRAWINGS

FIG. 1 depicts an exemplary, non-limiting LP-SVM classifier in the plane in Rⁿ containing w, according to an embodiment of the invention.

FIG. 2 is a flow chart of an exemplary method for formulating a contiguous support vector machine classifier, according to an embodiment of the invention.

FIG. 3 depicts examples of four volumes from Cologne after intensity and spatial normalization, according to an embodiment of the invention.

FIG. 4 depicts a single axial image showing the regions picked by a method according to an embodiment of the invention, overlayed on an image of an Alzheimer's disease patient SPECT image.

FIG. 5 is a block diagram of an exemplary computer system for implementing a contiguous support vector machine classifier according to an embodiment of the invention.

### DETAILED DESCRIPTION OF THE PREFERRED EMBODIMENTS

Exemplary embodiments of the invention as described herein generally include systems and methods for a linear programming based classifier, similar to the 1-norm support vector machines, that use voxel intensities as features and incorporate proximity information about the features to generate a classifier that not only selects the most relevant voxels but the most relevant “areas” for classification, resulting in more robust classifiers that are better suitable for interpretation.

The notation used herein is as follows. The notation AεR^{m×n} signifies a real m×n matrix. For such a matrix, A will denote the transpose of A and Aᵢ will denote the i-th row of A. All vectors will be column vectors. For xεRⁿ, |x|ₚ denotes the p-norm, p=1, 2, . . . , ∞. A vector of ones in a real space of arbitrary dimension will be denoted by e. Thus, for eεR^{m} and yεR^{m}, e y is the sum of the components of y. A vector of zeros in a real space of arbitrary dimension will be denoted by 0. A separating hyperplane, with respect to two given point sets A and B, is a plane that attempts to separate Rⁿ into two halfspaces such that each open halfspace contains points mostly of A or B.

A classifier based approach assumes that a same position in a volume coordinate system within different volumes corresponds to the same anatomical position. This makes it possible to do meaningful voxel-wise comparisons between images. However some pre-processing of the image is usually required before this assumption can be satisfied. First, the subject being imaged is not always positioned at the same position in the reference frame of the imaging device. This reference frame defines where, for example, the brain is positioned in the image. Second, the anatomy does not always have the same shape and size between different subjects. For example, the size and shape of the skull can vary widely between subjects.

Thus, the spatial volumes being classified should be spatially registered. In the case of HMPAO-SPECT images of the subjects, detailed knowledge of the anatomy of the subjects is not available. These HMPAO-SPECT images are known as functional images, in that they only depict regional blood flow of the subject. The regional cerebral blood flow provides gross information about the anatomy based on the fact that there is a relationship between the blood flow and the underlying anatomy. Understanding this characteristic of HMPAO SPECT images guides the choice of a registration method.

Because of the limited anatomical information available in the volumes, affine transformations between the volumes were estimated, as opposed to transformations with a larger number of degrees of freedom. A correlation ratio was used as the similarity measure that was minimized using Powell optimization. A more robust result can be obtained from the following procedure. First, register all volumes to a single volume, then calculate a mean volume. This mean volume is then put on the midsagittal plane by registering it with a flipped version. Next, take the mean of the volume with a flipped version to make it symmetrical. Finally, all volumes were matched to this volume.

Another property of HMPAO SPECT imaging is that the image volumes it generates only provide a relative measure of the blood flow with respect to other regions of the brain. Direct comparison of the voxel intensities between images, even different acquisitions of the same subject, is thus not possible without normalization of the intensities.

Intensities can be normalized by applying an affine transformation to the intensities. The transformation parameters are estimated on the training set of each experiment such that the intensities for each voxel position have zero mean and standard deviation of one for all the training subjects. This normalization scheme provides numerical stability to the algorithms involved.

The hypo-perfusion pattern for early AD is not very well defined. A classification method according to an embodiment of the invention uses implicit knowledge about perfusion patterns obtained from a database of images of AD patients and normal subjects, rather than using explicit knowledge about typical perfusion patterns. To distinguish images of AD patient from normal subjects, a classifier that uses voxel intensities as features is utilized, and is trained on this image database. Using voxel intensities as features makes it possible to not introduce particular knowledge about the exact location of hypo-perfusion area(s). By using a database of images and the voxel intensities, one can circumvent exactly defining the typical perfusion pattern for early AD.

In general, the number of images available in the training databases is significantly smaller (<100) than the number of voxels (>1000). Thus the number of features (voxels) is much larger than the number of samples (training images). The number of samples is considered to be small if it is about the same as or smaller than the number of dimensions. In classical pattern recognition, it is believed that a good generalization cannot be obtained for cases using the whole feature space. Generalization is the capacity of a classifier to correctly classify a sample never before seen. In order to improve generalization of a classifier, a minimal feature dependency of the classifier is desired.

Feature classification in a digital dataset can be regarded as an example of classifying m points in an n− dimensional input space Rⁿ as being members of one of two classes. The set of points can be represented by an m×n matrix A, where the ith point is represented by a row Aᵢ. Each point Aᵢ is a member of either class A⁺ or A⁻, and this classification can be represented by an m×m diagonal matrix D with plus ones or minus ones along its diagonal. The type of classification can be represented by a linear support vector machine with a linear kernel with parameter v>0:

$${min}_{( w , γ , y ) ∈ {R}^{n + 1 + m}} v {\sum }_{i = 1}^{m} {y}_{i} + {\sum }_{j = 1}^{n} \vert {w}_{j} \vert such that$$

$${A}_{i} w + {y}_{i} \geq γ + 1 for {D}_{ii} = 1$$

$${A}_{i} w - {y}_{i} \leq γ - 1 for {D}_{ii} = - 1$$

$${y}_{i} \geq 0 , i = 1 , … , m$$

Rewriting this equation in matrix notation, and taking into account that D is a diagonal matrix of ±1, this program becomes:

$${min}_{( w , γ , y ) ∈ {R}^{n + 1 + m}} v {e}^{′} y + \frac{1}{2} {w}^{′} w such that$$

$$D ( Aw - e γ ) + y \geq e$$

$$y \geq 0$$

Here, the plane x′w=γ+1 bounds the class A⁺ points, while the plane x′w=γ−1 bounds the class A⁻ points as follows:
Aᵢw≧γ+1,
for Dᵢᵢ=1,
Aᵢw≦γ−1,
for Dᵢᵢ=−1.
The linear separating surface is the plane x′w=γ midway between the bounding planes. This formulation maximizes the margin, the distance between the two bounding planes, using a 1-norm, and results with a margin in terms of the 1-norm,

$$\frac{2}{{‖ w ‖}_{1}} .$$

This mathematical program is equivalent to:

$${min}_{( w , γ , y , v ) ∈ {R}^{n + 1 + m + n}} v {e}^{′} y + {e}^{′} v = v {\sum }_{i = 1}^{m} {y}_{i} + {\sum }_{j = 1}^{n} {v}_{j} , such that \\ D ( Aw - e γ ) + y ≻ e \\ v \geq w \geq - v \\ y \geq 0. \qquad ( 1 )$$

Empirical evidence indicates that the 1-norm formulation has the advantage of generating very sparse solutions. This results in the normal w to the separating plane x′w=γ having many zero components, which implies that many input space features do not play a role in determining the linear classifier. This makes this approach suitable for feature selection in classification problems. Note that, in addition to the conventional interpretation of smaller u as emphasizing a larger margin between the bounding planes, a smaller v also results in a sparser solution. The “right” value of υ is determined by a tuning procedure to the desired compromise between classification performance and the sparseness of the solution.

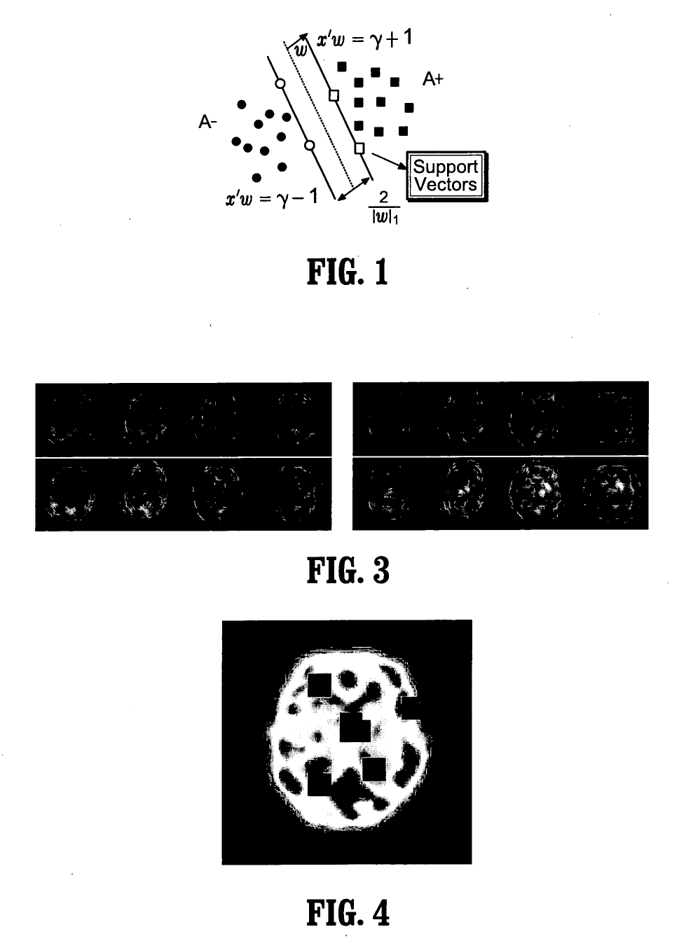

FIG. 1 depicts an exemplary, non-limiting LP-SVM classifier in the plane in Rⁿ containing w, according to an embodiment of the invention. The “soft margin” that approximately separates points in A+ from points in A− is indicated by the solid lines, while the plane represented by the above equations that separates the points of A+ from those of A− is indicated by the dotted line in the soft margin.

Two issues concerning standard SVM formulations of imaging classification are the fact that little or no spatial information about the imaging problem is incorporated into the optimization problem, and the interpretability of the results. For example, it is easier to interpret a final classifier depending on contiguous voxels defining regions than a subset of independent voxels with no apparent connection among them. However, for imaging applications where features are related to voxel/pixel intensities, the first issue can be addressed by predefining a relation among the voxels using spatial information or previous knowledge about the structure of the image. The second issue can be addressed by a feature selection scheme that not only obtains sparse models but also determines which of the input features are relevant for the classification task, leading to insights about the application.

A classifier according to an embodiment of the invention incorporates spatial information about every voxel into the optimization problem in a manner that the final obtained hyperplane classifier depends on regions or clusters of features rather than on isolated voxels.

Consider a similarity function r that defines binary relations among any two features (fᵢ, fⱼ) of any given training datapoint. Let R be a matrix such that:
Rᵢⱼ=r(fᵢ,fⱼ)ε{0,1},i,jε{1, . . . ,n}.
Define \hat{R}=R−I_{n×n}, where \hat{R} is the symmetric adjacency matrix of an undirected graph representing the relation among the features according to the relation function r. R is a pseudo-adjacency matrix of a graph where every node has a self-loop. Typically, R is based on local relations and therefore is a sparse matrix. Note that the function r can be defined more generally, where instead of a binary relation it can be a similarity function or any other kind of function encoding extra information about the features or the datapoints in the training set.

According to an embodiment of the invention, the relation r is defined by a 3×3×3 mask defining the 26-closest neighbors of each voxel. Note that this simple local mask allows one to encode the sense of contiguity among voxels in a global sense across the whole volume.

According to an embodiment of the invention, a method to incorporate this extra information about the features encoded in R into the 1-norm SVM disclosed above is as follows:

$${min}_{( w , γ , y , v ) ∈ {R}^{n + 1 + m + n}} v {e}^{′} y + {e}^{′} v = v {\sum }_{i = 1}^{m} {y}_{i} + {\sum }_{j = 1}^{n} {v}_{j} , such that \\ D ( Aw - e γ ) + y \geq e \\ Rv \geq w \geq - Rv \\ y \geq 0. \qquad ( 2 )$$

At a solution of equation (1), v is the absolute value |w| of w. This fact follows from the constraints v≧w≧−v which imply that vᵢ≧|wᵢ|i=1, . . . , n. Hence at optimality, v=|w|, otherwise the objective function can be strictly decreased without changing any variable except v. In equation (2), Rv=|w| at optimality, this is:

$$\vert {w}_{i} \vert = {\sum }_{j = 1}^{n} {R}_{ij} {v}_{j} = {\sum }_{\{ j \vert {r}_{i , j} = 1 \}} {R}_{ij} {v}_{j} .$$

This means that the magnitude of the weight wᵢ of the related feature i not only depends on itself but also depends on all the features j that are related to i according to the relation function r.

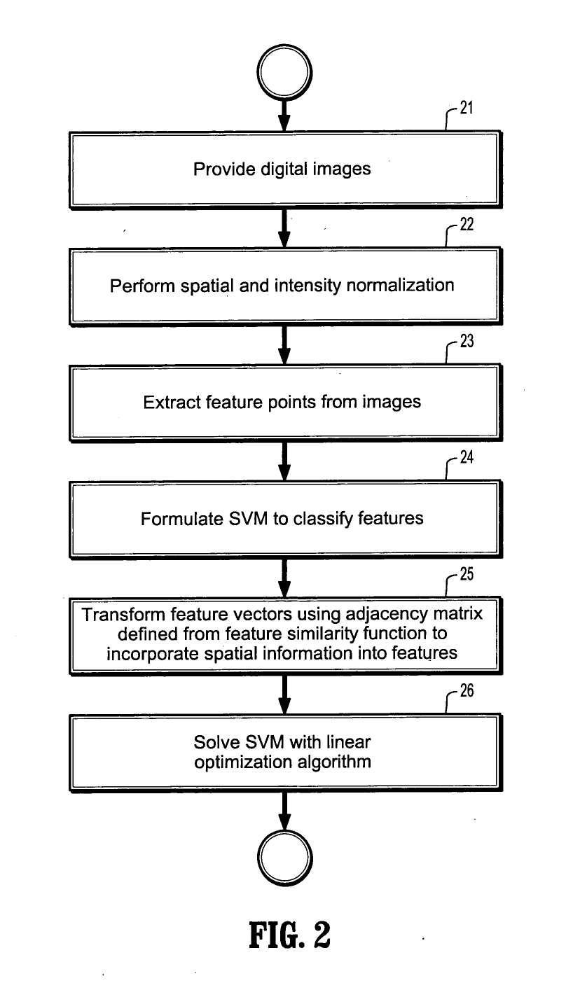

FIG. 2 is a flow chart of an exemplary method for formulating a contiguous support vector machine classifier according to an embodiment of the invention. At step 21, a plurality of images are provided. The images can be of any imaging modality, such as CT, MRI or US, and could even be analog images as long as they are digitized prior to further processing. At step 22, the images are spatially registered and intensity normalized as disclosed above. Features are extracted from the images at step 23, using voxel intensities as the features. A support vector machine for classifying the feature points is formulated at step 24. At step 25, spatial information is incorporated into the feature vectors by transforming them by an adjacency matrix defined by the feature similarity function. The modified SVM, referred to as the contiguous SVM (CSVM), is solved at step 26 by a linear optimization algorithm as are known in the art. The results of the classification can indicate whether the extracted features are indicative of Alzheimer's disease.

A method according to an embodiment of the invention was tested on images taken from a concurrent study investigating the use of SPECT as a diagnostic tool for the early onset of AD. A detailed description of this data can be found in Soonawala, et al., “Statistical parametric mapping of (99m)Tc-HMPAO-SPECT images for the diagnosis of Alzheimer's disease: normalizing to cerebellar tracer uptake.” Neuroimage, 17(3): 1193-1202, November 2002, the contents of which are incorporated herein by reference. Subjects of four different centers, Edinburgh (Scotland), Nice (France), Genoa (Italy), and Cologne (Germany) were included for this study. In total, 158 subjects participated, including 99 patients with AD, 28 patients suffering from depression (not used in this article), and 31 healthy volunteers. Confirmation of Alzheimer's disease was obtained by clinical follow-up. There was no statistically significant age difference between the AD patients and the healthy subjects. For technical acquisition related reasons images of 7 AD subjects had to be excluded.

FIG. 3 depicts examples of four volumes from Cologne after intensity and spatial normalization, according to an embodiment of the invention. In each column the first two small images show two normal subjects, the last two images show slices of AD subjects. The sets of slices are ordered from left to right and from top to bottom. Strong hypo-perfusion can be seen for the first AD patient, whereas the hypo-perfusion is more subtle for the second patient.

Applying the registration procedure as described above results in images of 128 by 128 by 89 voxels, with a voxel size of 1.71 mm by 1.71 mm by 1.88 mm for all four centers. The SPECT images have an effective resolution of about 7 mm full width at half maximum. Therefore one can subsample the images a factor of two in each dimension by taking the average value over the subsampled areas without loosing much information. Only the voxel intensities for the voxels in the part of the brain that has been imaged for all subjects are used. Applying this procedure results in 3816 features per subject available for classification/feature selection.

All real images were rated in four categories (very probable, probably, probably not and very unlikely to have AD) by sixteen European expert nuclear medicine physicians. The possible ratings were as follows: very probably Alzheimer's disease, probably Alzheimer's disease, probably not Alzheimer's disease and very unlikely Alzheimer's disease. To be able to compare the data from the experts with that of the automatic methods, the first two ratings were considered as positive and the other two as negative.

In all of these experiments the data was divided into two disjoint training and testing sets. The parameters were tuned by only using data from the training set, and once the final model is fixed, testing it on the unseen testing set. A leave-one-out cross validation was used to tune the model parameter i) of the contiguous SVM (CSVM) according to an embodiment of the invention. For solving the optimization problems involved, the commercial available solver CPLEX 6.5 was used. Performance of the CVSM was compared to a statistical parametric mapping (SPM) approach and to a Fisher's Linear Discriminant (FLD) classifier.

Two set of experiments were performed:

1. The 123 cases were randomly divided into 90 training examples and 33 testing examples to approximately measure the generalization capability of the proposed classifier.

2. The generalization performance across institutions was tested by dividing the data into two different subsets according to the institution from which they were collected. The training set consists of 68 cases coming from Genoa (34 cases) and Cologne (34 cases) and the testing set consists of 55 cases coming from Edinburgh (28 cases) and Nice (27 cases).

The first experiment resulted in a selection of 253 features grouped in 7 connected areas. Most selected groups of features are in the ventricles. This is consistent with the general atrophy of the brain, observed in Alzheimer's disease patients, which enlarges the ventricles relative to the other parts of the brain. This result shows the potential of an approach according to an embodiment of the invention at selecting meaningful grouped features which can be interpreted more easily than traditional feature selection approaches.

FIG. 4 depicts a single axial image showing the regions picked by a method according to an embodiment of the invention, overlayed on an image of an Alzheimer's disease patient SPECT image.

The experts had an average sensitivity of 56.6% and a specificity of 82.4% for all 123 cases. The SPM approach was used at a significance level of 0.1 at the cluster level. Each image where some significant clusters were found to have a positive result were considered, leading to a sensitivity of 55.9% and a specificity of 77.4% for SPM. A classification approach according to an embodiment of the invention outperforms both the experts and the SPM approach. Even if performance decreases on the training set due to differences in the way the images were acquired at the different institutions, an approach according to an embodiment of the invention still shows good generalization capabilities.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

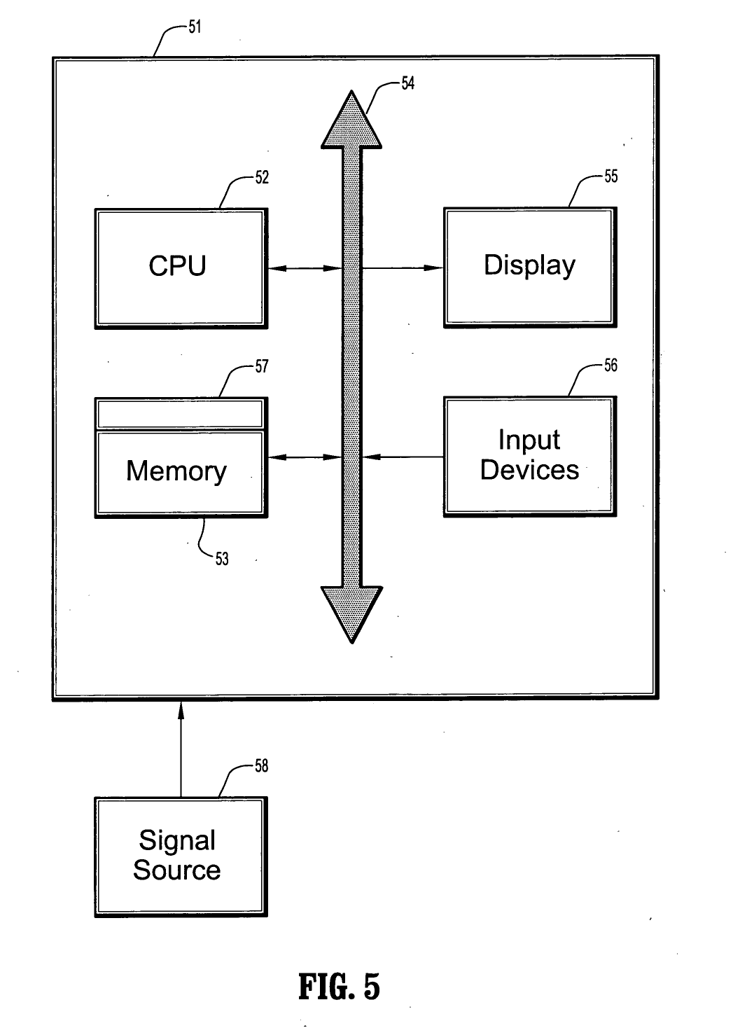

FIG. 5 is a block diagram of an exemplary computer system for implementing a CVSM according to an embodiment of the invention. Referring now to FIG. 5, a computer system 51 for implementing the present invention can comprise, inter alia, a central processing unit (CPU) 52, a memory 53 and an input/output (I/O) interface 54. The computer system 51 is generally coupled through the I/O interface 54 to a display 55 and various input devices 56 such as a mouse and a keyboard. The support circuits can include circuits such as cache, power supplies, clock circuits, and a communication bus. The memory 53 can include random access memory (RAM), read only memory (ROM), disk drive, tape drive, etc., or a combinations thereof. The present invention can be implemented as a routine 57 that is stored in memory 53 and executed by the CPU 52 to process the signal from the signal source 58. As such, the computer system 51 is a general purpose computer system that becomes a specific purpose computer system when executing the routine 57 of the present invention.

The computer system 51 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

While the present invention has been described in detail with reference to a preferred embodiment, those skilled in the art will appreciate that various modifications and substitutions can be made thereto without departing from the spirit and scope of the invention as set forth in the appended claims.

What is claimed is:

1. A method of classifying features in digitized images comprising the steps of:
providing a plurality of feature points in an n-dimensional space, wherein said feature points have been extracted from a digitized medical image;
formulating a support vector machine to classify said feature point into one of two sets, wherein each said feature classification vector is transformed by an adjacency matrix defined by those points that are nearest neighbors of said feature; and
solving said support vector machine by a linear optimization algorithm to determine a classifying plane that separates the feature vectors into said two sets.

2. The method of claim 1, wherein said features are extracted from a plurality of digitized images, wherein each said image comprises a set of intensities defined on a lattice of points, and further comprising spatially registering each of said images by estimating an affine transformation between the images.

3. The method of claim 2, wherein spatially registering said images further comprises registering each image to a single image, registering said single image to a flipped version of itself, and averaging said single image with said flipped version of itself.

4. The method of claim 2, wherein the intensities of each said image are normalized by application of an affine transformation to said intensities.

5. The method of claim 4, wherein said affine transformation parameters are estimated on a training set of features wherein the intensities for each training set point have zero mean and a standard deviation of one.

6. The method of claim 2, wherein the lattice point intensities are used as features.

7. The method of claim 1, wherein said adjacency matrix R is defined by a similarity function r among any two features (fᵢ, fⱼ) wherein a matrix element Rᵢⱼ is defined by Rᵢⱼ=r(fᵢ,fⱼ)ε{0,1}, i,jε{1, . . . , n}, wherein n is a number of features.

8. The method of claim 7, wherein the similarity function is defined by a 3%3%3 mask that selects the 26 nearest neighbors of each said feature.

9. The method of claim 1, wherein said features include hypo-perfusion patterns characteristic of Alzhiemer's disease.

10. A method of classifying features in digitized images comprising the steps of:
providing a plurality of digitized images, wherein each said image comprises a set of intensities defined on a lattice of points, a
spatially registering each of said images by estimating an affine transformation between the images;
normalizing the intensities of each of said images by application of an affine transformation to said intensities;
extracting a plurality of feature points from said digitized images; and
transforming each said feature by an adjacency matrix R defined by a similarity function r among any two features (fᵢ,fⱼ) wherein a matrix element Rᵢⱼ is defined by Rᵢⱼ=r(fᵢ,fⱼ)ε{0,1}, i,jε{1, . . . ,n}, wherein n is a number of features, wherein spatial information is incorporated into each said feature.

11. The method of claim 10, further comprising formulating a formulating a support vector machine to classify said transformed feature point into one of two sets, and solving said support vector machine by a linear optimization algorithm.

12. A program storage device readable by a computer, tangibly embodying a program of instructions executable by the computer to perform the method steps for classifying features in digitized images, said method comprising the steps of:
providing a plurality of feature points in an n-dimensional space, wherein said feature points have been extracted from a digitized medical image;
formulating a support vector machine to classify said feature point into one of two sets, wherein each said feature classification vector is transformed by an adjacency matrix defined by those points that are nearest neighbors of said feature; and
solving said support vector machine by a linear optimization algorithm to determine a classifying plane that separates the feature vectors into said two sets.

13. The computer readable program storage device of claim 12, wherein said features are extracted from a plurality of digitized images, wherein each said image comprises a set of intensities defined on a lattice of points, and further comprising spatially registering each of said images by estimating an affine transformation between the images.

14. The computer readable program storage device of claim 13, wherein spatially registering said images further comprises registering each image to a single image, registering said single image to a flipped version of itself, and averaging said single image with said flipped version of itself.

15. The computer readable program storage device of claim 13, wherein the intensities of each said image are normalized by application of an affine transformation to said intensities.

16. The computer readable program storage device of claim 15, wherein said affine transformation parameters are estimated on a training set of features wherein the intensities for each training set point have zero mean and a standard deviation of one.

17. The computer readable program storage device of claim 13, wherein the lattice point intensities are used as features.

18. The computer readable program storage device of claim 12, wherein said adjacency matrix R is defined by a similarity function r among any two features (fᵢ,fⱼ) wherein a matrix element Rᵢⱼ is defined by Rᵢⱼ=r(fᵢ,fⱼ)ε{0,1},i,jε{1, . . . ,n}, wherein n is a number of features.

19. The computer readable program storage device of claim 18, wherein the similarity function is defined by a 3%3%3 mask that selects the 26 nearest neighbors of each said feature.

20. The computer readable program storage device of claim 12, wherein said features include hypo-perfusion patterns characteristic of Alzhiemer's disease.
